(19) United States
(12) Patent Application Publication
(10) Pub. No.: US 2012/0140477 A1
(43) Pub. Date: Jun. 7, 2012

(54) LED LAMP

(75) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/279,349

(22) Filed: Oct. 24, 2011

(30) Foreign Application Priority Data
Dec. 6, 2010 (TW) 099142471

(51) Int. Cl. F21S 10/00

(52) U.S. Cl. 362/281; 362/277

(57) ABSTRACT

An LED lamp includes a frame, an LED module, a plurality of reflecting plates, and a plurality of adjusting members. The frame includes a base and a holder mounted on the base. The base defines a plurality of slots. The holder forms a plurality of fixing positions. The LED module is received in the frame. The reflecting plates are pivotably engaged with the base and extend through the slots of the base to surround the LED module. The adjusting members respectively interconnect the reflecting plates and the holder. Each of the adjusting members is selectively fixed to one of the plurality of fixing positions of the holder. Each of the reflecting plates is capable of rotating with respect to the base of the frame during change of the fixing position of the adjusting member to the holder.

### BACKGROUND

1. Technical Field

The disclosure relates to light emitting diodes (LEDs) and, more particularly, to an LED lamp providing adjustable illumination area.

2. Description of the Related Art

LEDs have advantages of resistance to impact and nearly limitless lifetime under specific conditions. Such advantages make an LED lamp a cost-effective yet high quality replacement for incandescent and fluorescent lamps.

Known implementations of LED modules in an LED lamp use a plurality of individual LEDs to generate light reflected by a light-guiding module to obtain sufficient illumination of suitably wide distribution. A conventional light-guiding module is integrally fabricated and suited only for use in the type of LED lamp for which its use is intended. However, such light-guiding module limits the size of the illumination area and restricts adjustability of the LED lamp.

What is needed, therefore, is an LED lamp providing an adjustable illumination area, thereby overcoming the described limitations.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the present light emitting diode package for microminiaturization. Moreover, in the drawing, like reference numerals designate corresponding parts throughout the whole view.

FIG. 1 is an isometric, assembled view of an LED lamp in accordance with a first embodiment of the present disclosure.

FIG. 2 is an exploded view of the LED lamp of FIG. 1.

FIG. 3 is an inverted view of the LED lamp of FIG. 2.

FIG. 4 is an enlarged view of a circled portion IV of FIG. 2.

FIG. 5 is an enlarged view of a circled portion V of FIG. 2.

FIG. 6 is an isometric, assembled view of an LED lamp in accordance with a second embodiment of the present disclosure.

FIG. 7 is an exploded view of the LED lamp of FIG. 6.

FIG. 8 is an inverted view of the LED lamp of FIG. 7.

### DETAILED DESCRIPTION

Reference will be made to the drawing figures to describe the present electronic device in detail.

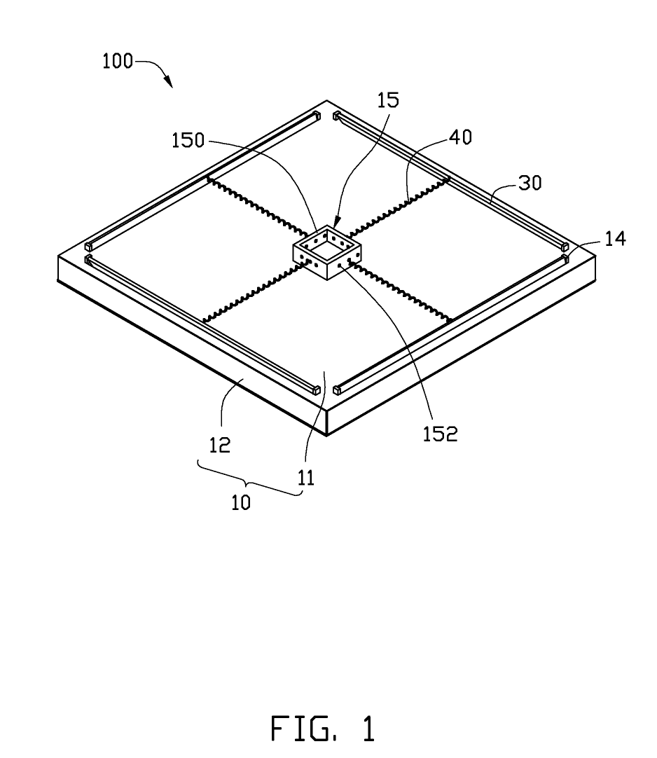

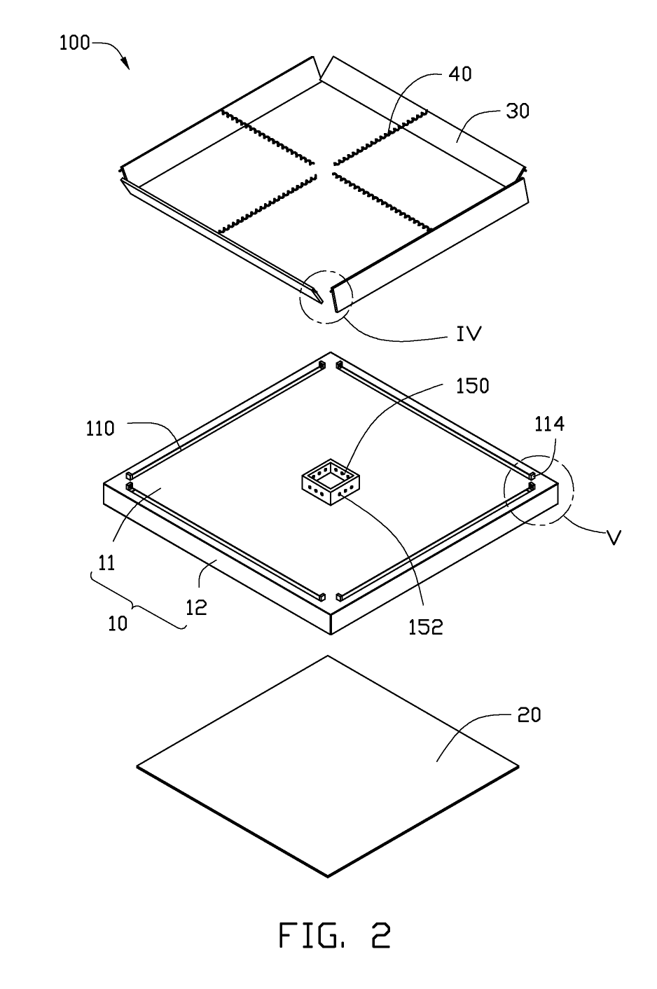

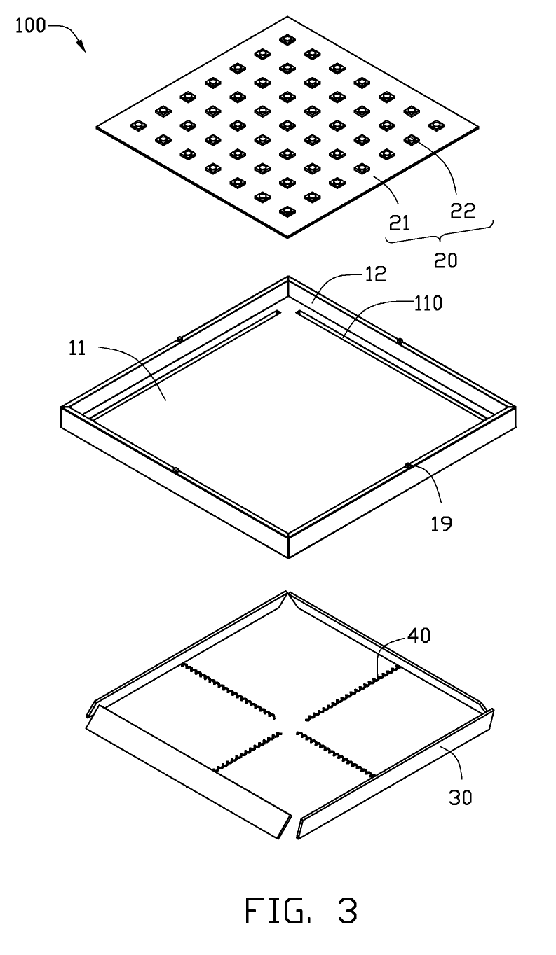

Referring to FIGS. 1-3, an LED lamp 100 in accordance with a first embodiment of the disclosure is shown. The LED lamp 100 includes a frame 10, an LED module 20 mounted at a bottom of the frame 10, a plurality of reflecting plates 30 pivotably engaged with the frame 10 and surrounding the LED module 20, and a plurality of adjusting members 40 connecting the reflecting plates 30 and the frame 10 for adjusting pivoted angles of the reflecting plates 30 relative to the frame 10.

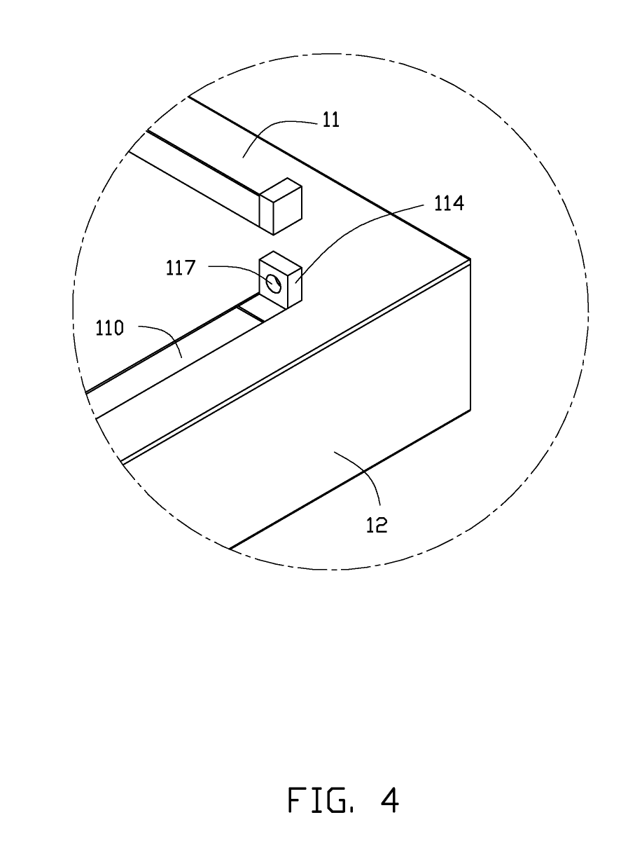

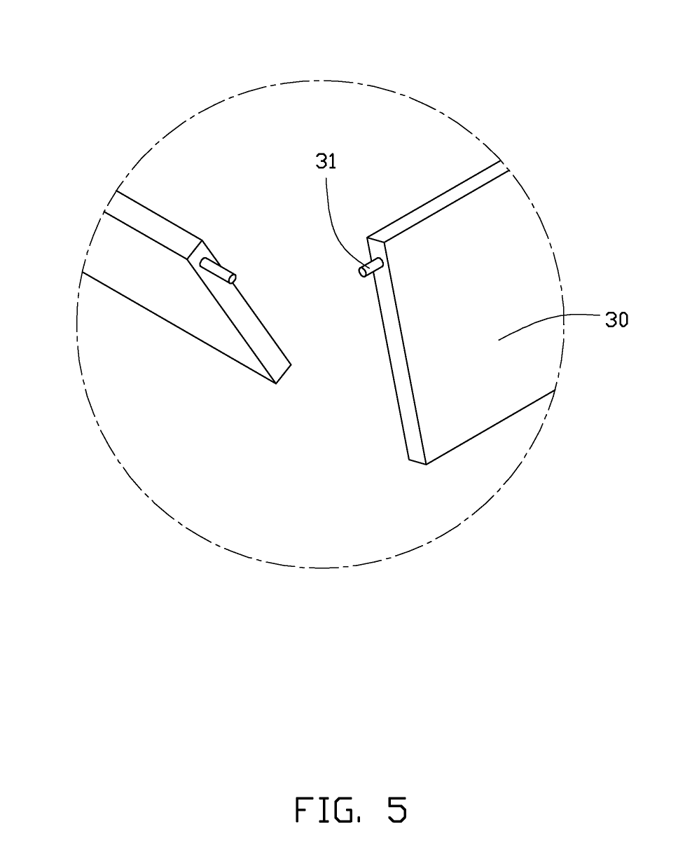

Referring also to FIGS. 4-5, the frame 10 includes a rectangular base 11 and four side walls 12 downwards extending from edges of the base 11. The base 11 defines four elongated slots 110 near the edges of the base 11 and accordingly near the four side walls 12, respectively. Each of the slots 110 is parallel to and spaced from the correspondingly neighboring side wall 12. A plurality of protrusions 114 upwards extend from the base 11 at two ends of each of the slots 110. Each of the protrusions 114 defines a pivot hole in an inner side thereof which faces the corresponding slot 110. A holder 15 is mounted at a center of a top of the base 11. The holder 15 is rectangular and includes four sidewalls 150 connecting to each other in sequence. Each of the sidewalls 150 defines a plurality of mounting holes 152 for fixing an inner end of the adjusting member 40. A distance between the joint of the adjusting member 40 and the reflecting plate 30 and one (for example a middle one) of the mounting holes 152 is different from a distance between the joint and another one of the mounting holes 152.

The LED module 20 includes a circuit board 21 attached to the base 11 and a plurality of LEDs 22 evenly mounted on the circuit board 21.

Each of the reflecting plates 30 has an elongated and rectangular shape. A thickness of each reflecting plate 30 is less than a width of the corresponding slot 110. Each reflecting plate 30 is coated with reflecting material at an inner surface thereof facing toward the LED module 20. Each reflecting plate 30 respectively forms two pivot portions 31 at two ends thereof to engage in the pivot holes 117 of the corresponding protrusions 114. The reflecting plates 30 extend through the slots 110 of the base 11 to the bottom of the frame 10 to surround the LED module 20. Alternatively, the pivot holes can be defined in the reflecting plate 30, while the pivot portions can be formed on the protrusions.

In this embodiment, the adjusting members 40 are springs each with a high spring constant. Each of the adjusting members 40 has a first end (i.e., outer end, not labeled) connecting with a top edge of one corresponding reflecting plate 30 and a second end (i.e., inner end, not labeled) connecting with the corresponding sidewall 150 of the holder 15. The second end of the adjusting member 40 can be mounted in different mounting holes 152 of the sidewall 150 of the holder 15 to rotate the reflecting plate 30 relative to the protrusions 114, thereby adjusting an angle of the reflecting plate 30 relative to the base 11 to a required angle. Accordingly, the illumination area of the LED lamp 100 in accordance with the present disclosure can be adjusted to satisfy different requirements.

It is understood that the quantities of the reflecting plates 30 and the sidewalls 150 are variable. Additionally, the adjusting member 40 can be operated by a controlling module (not shown), the LED lamp further includes a plurality of light sensors 19 mounted at bottoms of the four side walls 12 to sense an illumination intensity of the LED lamp 100. The light sensors 19 send controlling signal to the controlling module to control the rotating angles of the reflecting plates 30.

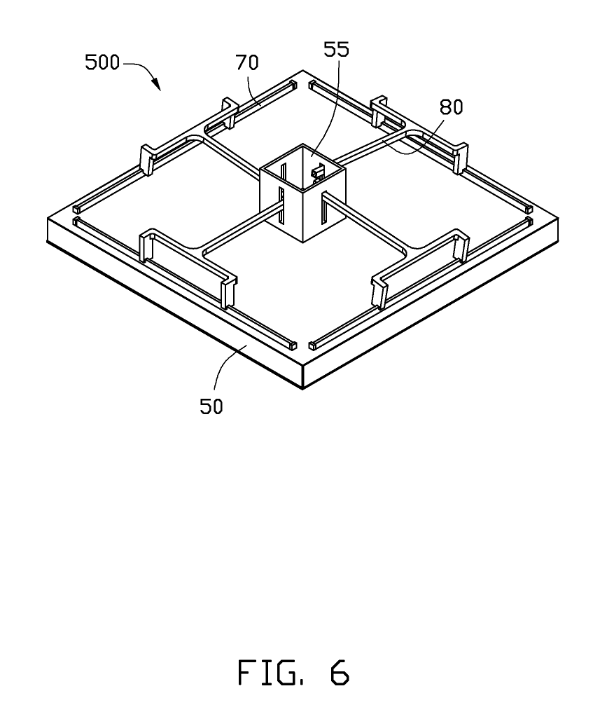

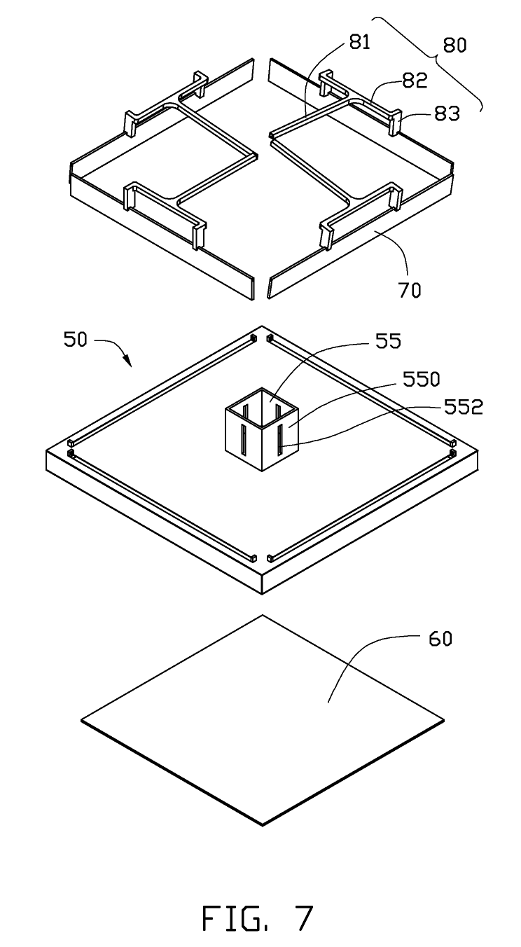

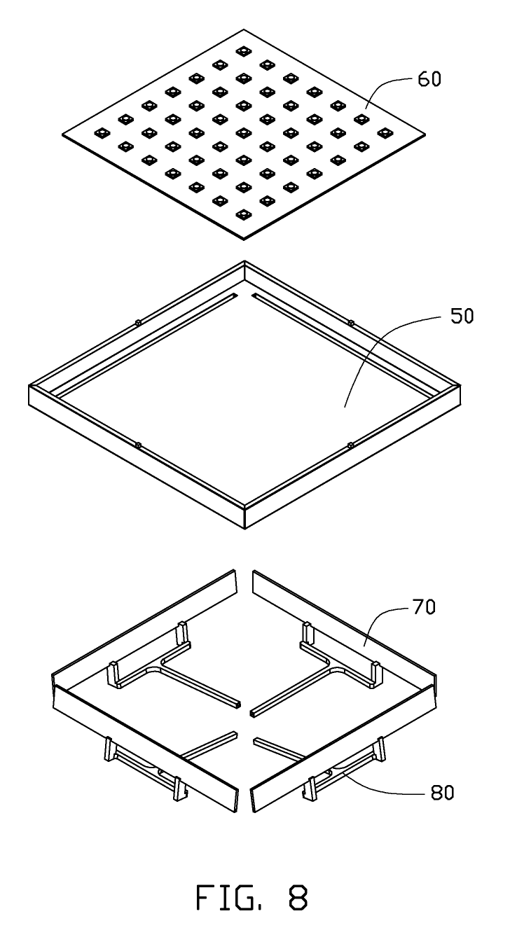

Referring to FIGS. 6-8, an LED lamp 500 in accordance with a second embodiment of the disclosure is shown. The LED lamp 500 includes a frame 50, an LED module 60 mounted on a bottom of the frame 50, a plurality of reflecting plates 70 pivotably engaged in the frame 50, and a plurality of adjusting members 80. The frame 50, the LED module 60 and the reflecting plates 70 are respectively similar to the frame 10, the LED module 20 and the reflecting plates 30 of the LED lamp 100 of the first embodiment.

The adjusting members 80 are rigid and made of metal or plastic. Each of the adjusting members 80 has a T-shaped configuration and includes a handle 81, two legs 83 connecting with the reflecting plate 70, and a connecting portion 82 connecting the legs 83 and the handle 81. The two legs 83 are formed on two opposite ends of the connecting portion 82. The handle 81 extends from a middle of the connecting portion 82. In the shown embodiment, the adjusting member 80 and the corresponding reflecting plate 70 are separately formed and then assembled together. Alternatively, the adjusting member 80 and the corresponding reflecting plate 70 can be integrally formed as a single piece. In this situation, the adjusting member 80 and the corresponding reflecting plate 70 are formed by plastic injection molding.

The frame 50 includes a holder 55 mounted at a center of a top thereof The holder 55 is hollow and rectangular and includes four sidewalls 550. Each of the sidewalls 550 includes a vertical groove 552. A free end of each handle 81 extends through the vertical groove 552 of the corresponding sidewall 550 and mounted to the holder 55 by fasteners (not shown) which can selectively secure the handle 81 at a desired position along the groove 552 of the holder 55. Thus, a level of the free end of each handle 81 relative to the frame 50 can be adjusted to adjust the orientation of the reflecting plate 70, thereby adjusting an angle of the reflecting plate 70 relative to the frame 50 to adjust the illumination area of the LED lamp 500. Different requirements of the illumination area of the LED lamp 500 can be easily achieved. Thus, the LED lamp 500 has an improved function regarding the adjustment of the illumination area and illumination intensity.

It is to be further understood that even though numerous characteristics and advantages have been set forth in the foregoing description of the embodiment(s), together with details of the structures and functions of the embodiment(s), the disclosure is illustrative only; and that changes may be made in detail, especially in the matters of shape, size, and arrangement of parts within the principles of the disclosure to the full extent indicated by the broad general meaning of the terms in which the appended claims are expressed.

What is claimed is:

1. A light emitting diode (LED) lamp comprising:
a frame comprising a base and a holder mounted on the base, the base defining a plurality of slots, the holder forming a plurality of fixing positions;
an LED module received in the frame;
a plurality of reflecting plates pivotably engaged with the base and extending through the slots of the base to surround the LED module; and
a plurality of adjusting members respectively interconnecting the reflecting plates and the holder, each of the adjusting members being selectively fixed to one of the plurality of fixing positions of the holder, each of the reflecting plates being capable of rotating with respect to the base of the frame during change of a corresponding adjusting member from one fixing position to another fixing position.

2. The LED lamp as claimed in claim 1, wherein the base forms a plurality of protrusions extending at two ends of each of the slots, the reflecting plates pivotably engaged with the protrusions.

3. The LED lamp as claimed in claim 2, wherein each of the protrusions defines a pivot hole facing a corresponding slot, each reflecting plate forming two pivot portions to engage in the pivot holes of corresponding protrusions.

4. The LED lamp as claimed in claim 1, wherein the holder defines a plurality of mounting holes to mount the adjusting members in different fixing positions.

5. The LED lamp as claimed in claim 4, wherein each of the adjusting members is a spring.

6. The LED lamp as claimed in claim 1, wherein each of the adjusting members comprises a handle engaged with the holder, two legs connecting with a corresponding reflecting plate, and a connecting portion connecting the legs and the handle.

7. The LED lamp as claimed in claim 1, wherein the holder defines a plurality of vertical grooves for extension of the handles of the adjusting members.

8. The LED lamp as claimed in claim 1, wherein the frame comprises a plurality of side walls extending downwards from a periphery of the base, the reflecting plates being parallel to and spaced from the side walls of the frame, respectively.

9. The LED lamp as claimed in claim 8, further comprising a plurality of light sensors mounted at bottoms of the side walls of the frame to sense an illumination intensity of the LED lamp.

10. A light emitting diode (LED) lamp comprising:
a frame forming a plurality of fixing positions;
an LED module received in the frame;
a plurality of reflecting plates pivotably engaged with the frame and surrounding the LED module; and
a plurality of adjusting members each connecting with one of the reflecting plates at a joint and the frame, each of the adjusting members being selectively fixed to one of the plurality of fixing positions of the frame, a distance between the joint and one of the fixing positions being different from a distance between the joint and another one of the fixing positions.

11. The LED lamp as claimed in claim 10, wherein the frame forms a plurality of protrusions, the reflecting plates pivotably engaged with the protrusions.

12. The LED lamp as claimed in claim 11, wherein each of the protrusions defines a pivot hole, each reflecting plate forming two pivot portions to engage in the pivot holes of corresponding protrusions.

13. The LED lamp as claimed in claim 10, wherein the frame forms a holder with a plurality of sidewalls, each of the sidewalls defining a plurality of mounting holes to mount a corresponding adjusting member in a selected one of the different fixing positions.

14. The LED lamp as claimed in claim 10, wherein each of the adjusting members comprises a handle engaged with the holder, two legs connecting a corresponding reflecting plate, and a connecting portion connecting the legs and the handle.

15. The LED lamp as claimed in claim 10, wherein the frame comprises a base, a holder mounted on a center of the base, and a plurality of side walls extending downwards from a periphery of the base, the reflecting plates being parallel to and spaced from the side walls of the frame, respectively.

16. An LED lamp comprising:
a frame;
an LED module attached to the frame;
a reflecting plate pivotably connected to a periphery of the frame for reflecting light of the LED module;
an adjusting member comprising a first end and an opposite second end, one of the frame and the reflecting plate forming a plurality of fixing positions, the first end being selectively connected to one of the plurality of fixing positions of the one of the frame and the reflecting plate, the second end being connected to the other one of the frame and the reflecting plate, an angle between the reflecting plate and the LED module being changed by changing the first end connecting with one of the fixing positions to connect with another of the fixing positions.

17. The LED lamp as claimed in claim 16, wherein the frame forms a plurality of protrusions, the reflecting plates pivotably engaged with the protrusions.

18. The LED lamp as claimed in claim 17, wherein each of the protrusions defines a pivot hole, each reflecting plate forming two pivot portions to engage in the pivot holes of corresponding protrusions.

19. The LED lamp as claimed in claim 16, wherein the frame forms a holder with a plurality of sidewalls, each of the sidewalls defining a plurality of mounting holes to mount a corresponding adjusting member in one of the different fixing positions.
